(19) United States
(12) Patent Application Publication
(10) Pub. No.: US 2021/0150892 A1
(43) Pub. Date: May 20, 2021

(54) VEHICLE OPERATING PARAMETERS

(71) Applicant: Ford Global Technologies, LLC, Dearborn, MI (US)

(72) Inventors: Lu Xu, Canton, MI (US); Linjun Zhang, Canton, MI (US); Juan Enrique Castorena Martinez, Southfield, MI (US); Codrin Cionca, Ann Arbor, MI (US)

(73) Assignee: Ford Global Technologies, LLC, Dearborn, MI (US)

(21) Appl. No.: 16/687,934

(22) Filed: Nov. 19, 2019

(51) Int. Cl. G08G 1/01; G06N 3/04; G05B 13/02; G06N 3/08

(52) U.S. Cl. CPC G08G 1/0125; G06N 3/04; G05D 1/0088; G06N 3/08; G05B 13/027

(57) ABSTRACT

First area operating parameters specifying operation of a vehicle within a first area are determined based on traffic data received from a plurality of infrastructure sensors within the first area. Second area operating parameters specifying operation of the vehicle within a second area are determined based on traffic data received from the infrastructure sensor within the second area. The second area is within the first area. Upon the vehicle operating within the first area, the first area operating parameters are provided to the vehicle, and upon the vehicle operating within the second area, the second area operating parameters are provided to the vehicle.

### BACKGROUND

Vehicles use sensors to collect data while operating, the sensors including, for example, radar, LIDAR, vision systems, infrared systems, and ultrasonic transducers. Vehicles can actuate the sensors to collect data while traveling along roadways. Based on the data, it is possible to determine vehicle operating parameters. For example, sensor data can indicate a location, a speed, an acceleration, etc., of a vehicle.

### BRIEF DESCRIPTION OF THE DRAWINGS

FIG. 1 is a block diagram illustrating an example vehicle control system.

FIG. 2 is a diagram illustrating an example first area in which the system of FIG. 1 would be implemented.

FIG. 3 is a diagram illustrating an example second area within the first area of FIG. 2 at which the system of FIG. 1 would be implemented.

FIG. 4 is an example diagram of a deep neural network that determines first area operating parameters and second area operating parameters.

FIG. 5 is a flowchart of an exemplary process for controlling vehicle operating parameters.

FIG. 6 is a flowchart of an exemplary process for operating the vehicle according to received operating parameters.

### DETAILED DESCRIPTION

A system includes a computer including a processor and a memory, the memory storing instructions executable by the processor to determine first area operating parameters specifying operation of a vehicle within a first area based on traffic data received from a plurality of infrastructure sensors within the first area. The instructions further include instructions to determine second area operating parameters specifying operation of the vehicle within a second area based on traffic data received from the infrastructure sensor within the second area. Wherein the second area is a subset that is less than all of the first area. The instructions further include instructions to, upon the vehicle operating within the first area, provide the first area operating parameters to the vehicle. The instructions further include instructions to, upon the vehicle operating within the first area, provide the first area operating parameters to the vehicle.

The first area operating parameters and the second area operating parameters can each specify at least a distance of the vehicle from a second vehicle and a speed of the vehicle.

Determining the second area operating parameters can include obtaining the second area operating parameters as output from a deep neural network.

The instructions can further include instructions to input the traffic data received from the infrastructure sensor within the second area into the deep neural network. Traffic data can include data indicating at least one of vehicle reaction time, pedestrian count, vehicle count, traffic flow, and traffic violations.

The instructions can further include instructions to input sensor data received from the vehicle into the deep neural network. The sensor data can include image data and location data.

The instructions can further include instructions to train the deep neural network with simulated data generated from image data received from infrastructure sensor.

Determining the first area operating parameters can include obtaining the first area operating parameters as output from the deep neural network.

The instructions can further include instructions to input the traffic data received from the plurality of infrastructure sensors within the first area into the deep neural network. Traffic data includes data indicating at least one of vehicle reaction time, pedestrian count, vehicle count, traffic flow, and traffic violations.

The instructions can further include instructions to train the deep neural network with simulated data generated from image data received from the plurality of infrastructure sensors.

Traffic data can include data indicating at least one of vehicle reaction time, pedestrian count, vehicle count, traffic flow, and traffic violations.

The instructions can further include instructions to, upon the vehicle departing the second area, provide the first area operating parameters to the vehicle.

The instructions can further include instructions to predict the vehicle will depart the second area based on a location and a heading of the vehicle.

The instructions can further include instructions to predict the vehicle will enter the second area based on a location and a heading of the vehicle.

The system can include a vehicle computer in communication with the computer via a network. The vehicle computer including a processor and a memory storing instructions executable by the processor to receive the first area operating parameters or the second area operating parameters from the computer and actuate one or more vehicle components to operate the vehicle according to the received operating parameters.

A method includes determining first area operating parameters specifying operation of a vehicle within a first area based on traffic data received from a plurality of infrastructure sensors within the first area. The method further includes determining second area operating parameters specifying operation of the vehicle within a second area based on traffic data received from the infrastructure sensor within the second area. The second area is a subset that is less than all of the first area. The method further includes, upon the vehicle operating within the first area, providing the first area operating parameters to the vehicle. The method further includes, upon the vehicle operating within the second area, providing the second area operating parameters to the vehicle.

The first area operating parameters and the second area operating parameters can each specify at least a distance of the vehicle from a second vehicle and a speed of the vehicle.

Traffic data can include data indicating at least one of vehicle reaction time, pedestrian count, vehicle count, traffic flow, and traffic violations.

The method can further include, upon the vehicle departing the second area, providing the first area operating parameters to the vehicle.

The method can further include predicting the vehicle will enter the second area based on a location and a heading of the vehicle.

Further disclosed herein is a computing device programmed to execute any of the above method steps. Yet further disclosed herein is a computer program product, including a computer readable medium storing instructions executable by a computer processor, to execute an of the above method steps.

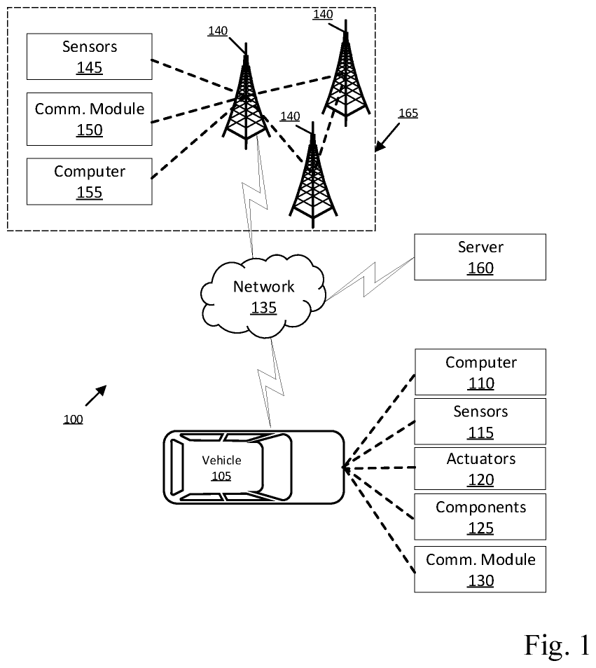

FIG. 1 is a block diagram illustrating an example vehicle control system 100 including a server 160, an infrastructure element 140, and a vehicle 105. The server 160 is programmed to determine first area 200 operating parameters specifying operation of the vehicle 105 within a first area based on traffic data received from a plurality of infrastructure sensors 145 within the first area. The server 160 is further programmed to determine second area 300 operating parameters specifying operation of the vehicle 105 within a second area based on data received from the infrastructure sensor 145 within the second area. The second area is a subset that is less than all of the first area. The server 160 is further programmed to, upon the vehicle 105 operating within the first area, provide the first area 200 operating parameters to the vehicle 105. The server 160 is further programmed to, upon the vehicle 105 operating within the second area, provide the second area 300 operating parameters to the vehicle 105.

The vehicle 105 includes sensors 115 that collect data while the vehicle 105 is operating. For example, the sensors 115 can collect traffic data of a location of the vehicle 105 while the vehicle 105 is operating along a route. Typically, the vehicle 105 operates along a plurality of routes within a second area to collect sensor 115 data prior to determining second area 300 operating parameters for the second area. Advantageously, infrastructure elements 140 can collect traffic data substantially continuously within the second area and transmit the data to a server 160, which allows the server 160 to determine second area 300 operating parameters for the second area. Using the server 160 to determine the second area 300 operating parameters allows the vehicle computer 110 to receive the second area 300 operating parameters upon the vehicle 105 entering a second area, e.g., without having previously operated within the respective second area. Additionally, the server 160 can determine first area 200 operating parameters for a first area enclosing one or more second areas based on the data received from the infrastructure elements 140 within the first area, which allows the vehicle computer 110 to receive first area 200 operating parameters for the first area upon the vehicle 105 entering the first area, e.g., without having previously operated within the first area.

The vehicle 105 includes a vehicle computer 110, sensors 115, actuators 120, vehicle components 125, and a vehicle communications module 130. The communications module 130 allows the vehicle computer 110 to communicate with one or more infrastructure elements 140 and the server 160, e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135.

The vehicle computer 110 includes a processor and a memory such as are known. The memory includes one or more forms of computer-readable media, and stores instructions executable by the vehicle computer 110 for performing various operations, including as disclosed herein.

The vehicle computer 110 may operate the vehicle 105 in an autonomous, a semi-autonomous mode, or a non-autonomous (or manual) mode. For purposes of this disclosure, an autonomous mode is defined as one in which each of vehicle 105 propulsion, braking, and steering are controlled by the vehicle computer 110; in a semi-autonomous mode the vehicle computer 110 controls one or two of vehicles 105 propulsion, braking, and steering; in a non-autonomous mode a human operator controls each of vehicle 105 propulsion, braking, and steering.

The vehicle computer 110 may include programming to operate one or more of vehicle 105 brakes, propulsion (e.g., control of acceleration in the vehicle 105 by controlling one or more of an internal combustion engine, electric motor, hybrid engine, etc.), steering, transmission, climate control, interior and/or exterior lights, etc., as well as to determine whether and when the vehicle computer 110, as opposed to a human operator, is to control such operations.

The vehicle computer 110 may include or be communicatively coupled to, e.g., via a vehicle communications network such as a communications bus as described further below, more than one processor, e.g., included in electronic controller units (ECUs) or the like included in the vehicle 105 for monitoring and/or controlling various vehicle components 125, e.g., a transmission controller, a brake controller, a steering controller, etc. The vehicle computer 110 is generally arranged for communications on a vehicle communication network that can include a bus in the vehicle 105 such as a controller area network (CAN) or the like, and/or other wired and/or wireless mechanisms.

Via the vehicle communications network, the vehicle computer 110 may transmit messages to various devices in the vehicle 105 and/or receive messages (e.g., CAN messages) from the various devices, e.g., sensors 115, an actuator 120, ECUs, etc. Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide data to the vehicle computer 110. For example, the sensors 115 may include Light Detection And Ranging (LIDAR) sensor(s) 115, etc., disposed on a top of the vehicle 105, behind a vehicle 105 front windshield, around the vehicle 105, etc., that provide relative locations, sizes, and shapes of objects surrounding the vehicle 105. As another example, one or more radar sensors 115 fixed to vehicle 105 bumpers may provide data to provide locations of the objects, second vehicles 106, etc., relative to the location of the vehicle 105. The sensors 115 may further alternatively or additionally, for example, include camera sensor(s) 115, e.g. front view, side view, etc., providing images from an area surrounding the vehicle 105. In the context of this disclosure, an object is a physical, i.e., material, item that can be represented by physical phenomena (e.g., light or other electromagnetic waves, or sound, etc.) detectable by sensors 115. Thus, vehicles 105, as well as other items including as discussed below, fall within the definition of “object” herein.

The vehicle computer 110 is programmed to receive data from one or more sensors 115, e.g., via the vehicle network. For example, the sensor 115 data may include a location of the vehicle 105. Location data may be in a known form, e.g., geo-coordinates such as latitude and longitude coordinates obtained via a navigation system, as is known, that uses the Global Positioning System (GPS). The vehicle computer 110 may, for example, be programmed to determine a heading of the vehicle 105 based on a coordinate system of the GPS. The heading of the vehicle 105 is defined with respect to a coordinate system, e.g., by an angle between a projected path of the vehicle 105 and the latitudinal or X axis of the GPS coordinate system. As used herein, a “projected path” is a predicted set of points over which the vehicle 105 will follow based on one or more elements of a vehicle 105 trajectory, e.g., a speed, a direction of travel, a position, an acceleration, etc.

Additionally, or alternatively, the sensor 115 data can include a location of an object, e.g., another vehicle, a pole, a curb, a bicycle, a pedestrian, etc., relative to the vehicle 105. As one example, the sensor 115 data may be image data of objects around the vehicle 105. Image data is digital image data, e.g., comprising pixels with intensity and color values, that can be acquired by camera sensors 115. The sensors 115 can be mounted to any suitable location in or on the vehicle 105, e.g., on a vehicle 105 bumper, on a vehicle 105 roof, etc., to collect images of the objects around the vehicle 105. The vehicle computer 110 can then transmit the sensor 115 data and/or the heading to the server 160 and/or one or more infrastructure computers 155, e.g., via the network 135.

The vehicle 105 actuators 120 are implemented via circuits, chips, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the vehicle computer 110 may be configured for communicating via a vehicle-to-vehicle communication module 130 or interface with devices outside of the vehicle 105, e.g., through a vehicle-to-vehicle (V2V) or vehicle-to-infrastructure (V2X) wireless communications to another vehicle, and/or to other computers (typically via direct radio frequency communications). The communications module 130 could include one or more mechanisms by which the computers 110 of vehicles 105 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), and/or wide area networks (WAN), including the Internet, providing data communication services.

The network 135 represents one or more mechanisms by which a vehicle computer 110 may communicate with remote computing devices, e.g., the infrastructure element 140, a server, another vehicle computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

An infrastructure element 140 includes a physical structure such as a tower or other support structure (e.g., a pole, a box mountable to a bridge support, cell phone tower, road sign support, etc.) on or in which infrastructure sensors 145, as well as an infrastructure communications module 150 and computer 155 can be housed, mounted, stored, and/or contained, and powered, etc. One infrastructure element 140 is shown in FIG. 1 for ease of illustration, but the system 100 could and likely would include tens, hundreds, or thousands of infrastructure elements 140.

An infrastructure element 140 is typically stationary, i.e., fixed to and not able to move from a specific physical location. The infrastructure sensors 145 may include one or more sensors such as described above for the vehicle 105 sensors 115, e.g., LIDAR, radar, cameras, ultrasonic sensors, etc. The infrastructure sensors 145 are fixed or stationary. That is, each infrastructure sensor 145 is mounted to the infrastructure element 140 so as to have a substantially unmoving and unchanging field of view.

Infrastructure sensors 145 thus provide field of views in contrast to vehicle 105 sensors 115 in a number of advantageous respects. First, because infrastructure sensors 145 have a substantially constant field of view, determinations of vehicle 105 and object locations can be accomplished with fewer and simpler processing resources than if movement of the infrastructure sensors 145 also had to be accounted for. Further, the infrastructure sensors 145 include an external perspective of the vehicle 105 and can sometimes detect features and characteristics of objects not in the vehicle 105 sensors 115 field(s) of view and/or can provide more accurate detection, e.g., with respect to vehicle 105 location and/or movement with respect to other objects. Yet further, infrastructure sensors 145 can communicate with the infrastructure element 140 computer 155 via a wired connection, whereas vehicles 105 typically can communicates with infrastructure elements 140 only wirelessly, or only at very limited times when a wired connection is available. Wired communications are more reliable and can be faster than wireless communications such as vehicle-to-infrastructure communications or the like.

The infrastructure communications module 150 and infrastructure computer 155 typically have features in common with the vehicle computer 110 and vehicle communications module 130, and therefore will not be described further to avoid redundancy. Although not shown for ease of illustration, the infrastructure element 140 also includes a power source such as a battery, solar power cells, and/or a connection to a power grid.

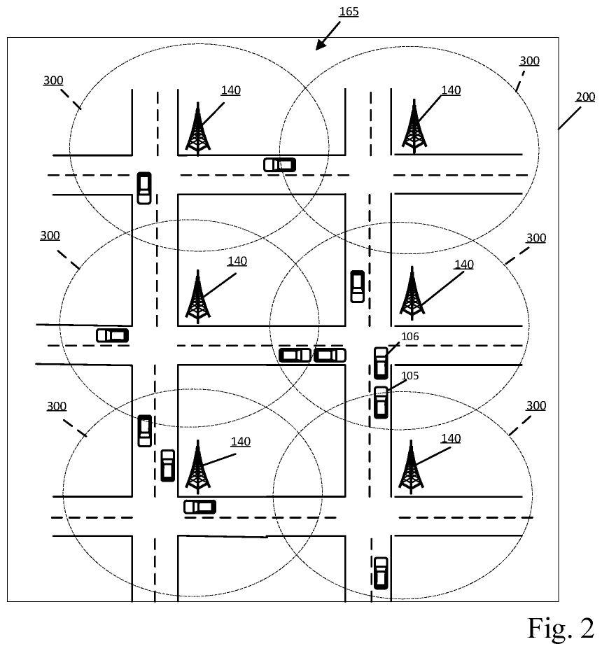

A first area 200 is defined for an infrastructure 165. The infrastructure 165 includes a plurality of infrastructure elements 140 in communication with each other, e.g., via the network 135. The plurality of infrastructure elements 140 are provided to monitor the first area 200 around the infrastructure elements 140, as shown in FIG. 2. The first area 200 may be, e.g., a neighborhood, a district, a city, a county, etc., or some portion thereof. The first area could alternatively be an area defined by a radius encircling the plurality of infrastructure elements 140 or some other distance or set of distances relative to the plurality of infrastructure elements 140.

In addition to vehicles 105, 106, a first area 200 can include other objects, e.g., a pedestrian, a bicycle object, a pole object etc., i.e., a first area 200 could alternatively or additionally include many other objects, e.g., bumps, potholes, curbs, berms, fallen trees, litter, construction barriers or cones, etc. Objects can be specified as being located according to a coordinate system for an area maintained by the vehicle computer 110 and/or infrastructure 140 computer 155, e.g., according to a Cartesian coordinate system or the like specifying coordinates in the first area 200. Additionally, data about an object could specify characteristics of a hazard or object in a sub-area such as on or near a road, e.g., a height, a width, etc.

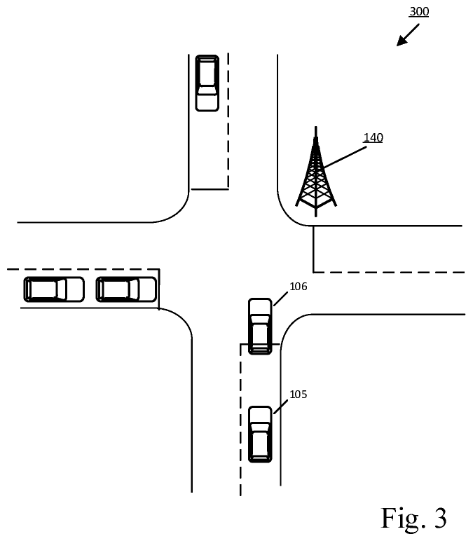

The first area 200 includes one or more second areas (i.e., sub-areas) 300, as shown in FIG. 2. Each infrastructure element 140 in the first area 200 is provided to monitor one respective sub-area 300. Each second area 300 is a subset that is an area of interest or focus for a particular traffic analysis, e.g., an intersection, a school zone, a railroad crossing, a construction zone, a crosswalk, etc., in the first area 200, as shown in FIG. 3. A second area 300 is proximate to a respective infrastructure element 140. In the present context, “proximate” means that the second area 300 is defined by a field of view of the infrastructure element 140 sensor 145. The second area 300 could alternatively be an area defined by a radius around the respective infrastructure element 140 or some other distance or set of distances relative to the respective infrastructure element 140.

The infrastructure computer 155 can determine traffic data of a second area 300, e.g., based on infrastructure sensor 145 data. For example, the infrastructure sensor 145 can capture data, e.g., image and/or video data, of the second area 300 and transmit the data to the infrastructure computer 155. Video data can be in digital format and encoded according to conventional compression and/or encoding techniques, providing a sequence of frames of image data where each frame can have a different index and/or represent a specified period of time, e.g., 10 frames per second, and arranged in a sequence. The infrastructure computer 155 can then analyze the infrastructure sensor 145 data, e.g., using pattern recognition and/or image analysis techniques, to determine the traffic data of the second area 300. The infrastructure computer 155 is programmed to then transmit the traffic data to the server 160, e.g., via the network 135.

Traffic data specifies movement and positions of vehicles relative to each other, e.g., during specific time periods (e.g., 7 am-9 am, 4 pm-6 pm, etc.), within the second area 300. Additionally, traffic data specifies movement and positions of pedestrians relative to vehicles, e.g., during specific time periods (e.g., 7 am-9 am, 4 pm-6 pm, etc.), within the second area 300. Traffic data can include any one or more of the following:

TABLE 1

| | | Example |
|---|---|---|
| Data | Explanation | Values |
| Traffic | An average speed of vehicles | 25 mph, |
| flow | operating in a second area | 40 kph, |
| | 300 during a specified time | 10 m/s, |
| | period. The traffic flow is | etc. |
| | determined based on an amount | |
| | of time for vehicles to travel | |
| | from a specified first point | |
| | to a specified second point | |
| | of a road. | |
| Vehicle | An average time for vehicles | 1.3 seconds, |
| Reaction | to change speed based on an | 2 seconds, |
| Time | event, such as a change of a | etc. |
| | traffic light, movement of | |
| | another vehicle, etc., in | |
| | the second area 300 during | |
| | a specified time period. A | |
| | vehicle reaction time is | |
| | determined based on an amount | |
| | of time from an event to a | |
| | substantial change in speed | |
| | of the vehicle. | |
| Vehicle | An average acceleration of vehicles | 3 m/s², |
| Acceleration | in the second area 300 during a | 1 m/s², |
| | specified time period. The vehicle | etc. |
| | acceleration is determined based | |
| | on an amount of time for vehicles | |
| | to increase a speed, e.g.,from | |
| | a stationary position, to the | |
| | traffic flow | |
| Vehicle | An average deceleration of vehicles | −3 m/s², |
| Deceleration | in the second area 300 during a | −1 m/s², |
| | specified time period. The vehicle | etc. |
| | deceleration is determined based | |
| | on an amount of time for vehicles | |
| | to decrease a speed, e.g., to a | |
| | stationary position, from the | |
| | traffic flow. | |
| Vehicle | Ae number of vehicles counted | 1) 5 vehicles, |
| count | operating in the second area 300 | 50 vehicles, |
| | during a specified time period. | etc. |
| Traffic | An indicium indicating a raw | 25 violations, |
| violations | number of traffic violations, | 15% chance of |
| | such as speeding, jaywalking, | a violation, |
| | tailgating, etc., in the second | etc. |
| | area 300 during a specified | |
| | time period, or a percent chance | |
| | of a traffic violation determined | |
| | by a raw number of traffic | |
| | violations during the specified | |
| | time period over a total number | |
| | of traffic violations. | |
| Vehicle | An average distance between two | 20 feet, |
| distance | vehicles operating in the second | 5 feet, |
| | area 300 during a specified time | 5 meters, |
| | period. The vehicle distance is | etc. |
| | determined based on a linear | |
| | distance from the exterior surface | |
| | of the vehicle 105 to the nearest | |
| | point on an exterior surface of | |
| | a second vehicle 106 in front of | |
| | the vehicle 105. | |
| Pedestrian | A number of pedestrians counted | 1) 50 pedestrians, |
| count | in the second area 300 during | 500 pedestrians, |
| | a specified time period. | etc. |
| Crosswalk | An average amount of time for | 1 minute, |
| time | pedestrians to cross a crosswalk | 45 seconds, |
| | in the second area 300 during | etc. |
| | a specified time period. The | |
| | crosswalk time is determined | |
| | based on an amount of time | |
| | for pedestrians to travel across | |
| | a crosswalk, i.e., from one | |
| | side of the road to the other | |
| | side of the road within a | |
| | crosswalk (e.g., normal to | |
| | a direction of travel of | |
| | vehicles on the road). | |
| Crosswalk | A number of pedestrians counted | 1) 50 pedestrians, |
| pedestrian | in a crosswalk in the second | 500 pedestrians, |
| count | area 300 during a specified | etc. |
| | time period | |

The infrastructure computer 155 may include an identifier that identifies the infrastructure computer 155 and the second area 300. In this context, an “identifier” is an alphanumeric string of data that corresponds to the infrastructure computer 155 and the second area 300. That is, the identifier identifies the specific infrastructure computer 155 and the specific second area 300. The infrastructure computer 155 may be programmed to transmit the identifier to the server 160, e.g., in a same or different transmission as the traffic data.

The server 160 is a computing device, i.e., including one or more processors and one or more memories, programmed to provide operations such as disclosed herein. Further, the server 160 can be accessed via the network 135, e.g., the Internet or some other wide area network. The server 160 may be programmed to receive traffic data from each infrastructure computer 155 within the first area 200, e.g., via the network 135. The server 160 can then store, e.g., in a memory, the traffic data from each infrastructure computer 155 within the first area 200. For example, the server 160 can store the traffic data based on the identifier of the infrastructure computer 155. Additionally, the server 160 can store, e.g., in a memory, sensor 115 data received, e.g., via the network 135, from the vehicle computer 110.

The server 160 determines first area 200 operating parameters of the vehicle 105 based on the traffic data received from the infrastructure computers 155 within the first area 200. The server 160 is programmed to determine, e.g., via a machine learning program, first area 200 operating parameters with decision-making algorithms utilized by a vehicle computer 110 to control, e.g., navigate, accelerate, decelerate, steer, etc., the vehicle 105. A first area 200 operating parameter is an expected value of a measurement of a physical characteristic of a vehicle 105 or an environment around that vehicle 105 while the vehicle 105 is operating in a respective first area 200. That is, the server 160 can determine respective first area 200 operating parameters for each of a plurality of first areas 200. For example, the server 160 can include a neural network, such as a deep neural network (DNN), that can be trained to accept traffic data, e.g., data indicating at least one of a vehicle reaction time, a pedestrian count, a vehicle count, a traffic flow, and traffic violations, from each of the plurality of infrastructure computers 155 within the first area 200 as input and generate an output of the first area 200 operating parameters.

Additionally, the server 160 determines second area 300 operating parameters of the vehicle 105 based on the traffic data received from the infrastructure computer 155 at the respective second area 300 and/or sensor 115 data from the vehicle 105 operating within the respective second area 300. The server 160 is programmed to determine, e.g., via a machine learning program, second area 300 operating parameters with decision-making algorithms utilized by a vehicle computer 110 to control, e.g., navigate, accelerate, decelerate, steer, etc., the vehicle 105. A second area 300 operating parameter is an expected value of a measurement of a physical characteristic of a vehicle 105 or an environment around that vehicle 105 while the vehicle 105 is operating within a respective second area 300. That is, the server 160 can determine respective second area 300 operating parameters for each second area 300. For example, the DNN can be trained to accept traffic data, e.g., data indicating at least one of a vehicle reaction time, a pedestrian count, a vehicle count, a traffic flow, and traffic violations, from the infrastructure computer 155 within the respective second area 300 and/or sensor 115 data, e.g., image data and location data, from the vehicle 105 operating within the respective second area 300 as input and generate an output of respective second area 300 operating parameters for each second area 300.

Non-limiting examples of operating parameters include vehicle speed, vehicle heading, vehicle acceleration, vehicle position relative to a lane, vehicle distance relative to a second vehicle 106, etc. The first area 200 operating parameters and the second area 300 operating parameters each specify at least a distance of the vehicle 105 from a second vehicle 106 and a speed of the vehicle 105. The distance of the vehicle 105 from a second vehicle 106 may be a linear distance from the vehicle 105, a radius centered at a point on the vehicle 105, or some other distance relative to the vehicle 105.

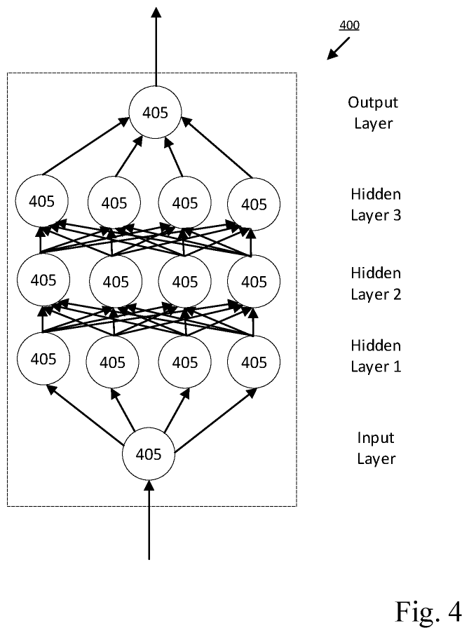

FIG. 4 is a diagram of an example deep neural network (DNN) 400. The DNN 400 can be a software program that can be loaded in memory and executed by a processor included in the server 160, for example. In an example implementation, the DNN 400 can include, but is not limited to, a convolutional neural network (CNN), R-CNN (Region-based CNN), Fast R-CNN, and Faster R-CNN. The DNN includes multiple nodes, and the nodes are arranged so that the DNN 400 includes an input layer, one or more hidden layers, and an output layer. Each layer of the DNN 400 can include a plurality of nodes 405. While FIG. 4 illustrate three (3) hidden layers, it is understood that the DNN 400 can include additional or fewer hidden layers. The input and output layers may also include more than one (1) node 405.

The nodes 405 are sometimes referred to as artificial neurons 405, because they are designed to emulate biological, e.g., human, neurons. A set of inputs (represented by the arrows) to each neuron 405 are each multiplied by respective weights. The weighted inputs can then be summed in an input function to provide, possibly adjusted by a bias, a net input. The net input can then be provided to an activation function, which in turn provides a connected neuron 405 an output. The activation function can be a variety of suitable functions, typically selected based on empirical analysis. As illustrated by the arrows in FIG. 4, neuron 405 outputs can then be provided for inclusion in a set of inputs to one or more neurons 405 in a next layer.

The DNN 400 can accept traffic data from the infrastructure computer 155 within respective second areas 300 and/or sensor 115 data, e.g., image data and location data, from the vehicle 105 as input and generate an output of respective second area 300 operating parameters for each second area 300. Additionally, the DNN 400 can accept traffic data from each of the plurality of infrastructure computers 155 within the first area 200 as input and generate an output of the first area 200 operating parameters. The traffic data may be any one or more of the data identified in Table 1 above.

As one example, the DNN 400 can be trained with ground truth data, i.e., data about a real-world condition or state. For example, the DNN 400 can be trained with ground truth data or updated with additional data by a processor of the server 160. The DNN 400 can be transmitted to the vehicle 105 via the network 135. Weights can be initialized by using a Gaussian distribution, for example, and a bias for each node 405 can be set to zero. Training the DNN 400 can include updating weights and biases via suitable techniques such as back-propagation with optimizations. Ground truth data can include, but is not limited to, data specifying objects, e.g., vehicles, pedestrians, crosswalks, etc., within an image or data specifying a physical parameter. For example, the ground truth data may be data representing objects and object labels. In another example, the ground truth data may be data representing an object, e.g., a vehicle 105, and a relative angle and/or speed of the object, e.g., the vehicle 105, with respect to another object, e.g., a second vehicle 106, a pedestrian, etc.

As another example, the DNN 400 can be trained based on simulated data. Simulated data is image data, e.g., received from the infrastructure computer(s) 155, and corresponding ground truth from a near-realistic simulated environment generated and rendered by computer software as opposed to being acquired by a video sensor included in a vehicle 105 and/or infrastructure element 140 in a real-world environment and including ground truth based on the real-world environment. A near-realistic simulated environment in this context means a software program that can generate and render images that appear, to a viewer, as a real photograph of a real-world environment (photo-realistic), for example, a roadway with vehicles. For example, computer gaming software can render photo-realistic video scenes of vehicles, roadways and backgrounds based on mathematical and logical descriptions of objects and regions in the simulated environment. Computer software can generate and render simulated data of real-world traffic scenes including roadways, vehicles, pedestrians and backgrounds at a rate fast enough to produce far more images and corresponding ground truth data sets than could be acquired by video sensors on vehicles 105 and/or infrastructure elements 140 acquiring data while vehicle 105 is operated on a roadway, e.g., proximate the infrastructure element(s) 140. The simulated traffic scenes can be selected to reproduce a plurality of roadway configurations, traffic, lighting and weather conditions likely to be found in real-world environments such as the first area 200 and/or the second area 300, for example. An example of a software program that can be used to produce simulated traffic scenes is TORCS, available at torcs.sourceforge.net as of the date of filing this application. Because the images included in the simulated data include information from a near-realistic simulated environment, the DNN 400 processes the images as if they included real data from a real-world environment.

During operation, the server 160 obtains traffic data, e.g., e.g., data indicating at least one of a vehicle reaction time, a pedestrian count, a vehicle count, a traffic flow, and traffic violations, from the infrastructure computer(s) 155 and provides the data as input to the DNN 400. The DNN 400 generates a prediction based on the received input. The output is one of the first area 200 operating parameters or the second area 300 operating parameters. In the case that the input is traffic data from each infrastructure computer 155 within the first area 200, the output specifies the first area 200 operating parameters. In the case that the input is traffic data from the infrastructure computer 155 within one second area 300, the output specifies the second area 300 operating parameters for that second area 300. The server 160 can then store, e.g., in a memory, the first area 200 operating parameters for the first area 200 and the respective second area 300 operating parameters for each second area 300 within the first area 200.

The server 160 is programmed to provide the first area 200 operating parameters to the vehicle computer 110 based on the vehicle 105 operating within the first area 200. For example, the server 160 can determine the vehicle 105 is operating within the first area 200 based on receiving location data from the vehicle computer 110. As another example, the server 160 can determine the vehicle 105 is operating within the first area 200 based on receiving infrastructure sensor 145 data detecting the vehicle 105 from an infrastructure computer 155 within the first area 200. The vehicle computer 110 can then operate the vehicle 105 within the first area 200 based on the first area 200 operating parameters. That is, the vehicle computer 110 can actuate one or more vehicle components 125 to operate the vehicle 105 at the distance from a second vehicle 106 and the speed specified by the first area 200 operating parameters.

Additionally, or alternatively, the server 160 can predict whether a vehicle 105 outside the first area 200 will enter the first area 200 based on determining the projected path of the vehicle 105 intersects a boundary of the first area 200. The boundary of the first area 200 may be defined by, e.g., a field of view of the infrastructure sensors 145 within the first area 200, GPS coordinates, geographical landmarks, etc. For example, the server 160 can determine the projected path of the vehicle 105 based on the heading received from the vehicle computer 110, e.g., via the network 135, and the GPS coordinate system. The server 160 can then compare the projected path of the vehicle 105 to the first area 200. In the case that the projected path of the vehicle 105 does not intersect the boundary of the first area 200, the server 160 predicts the vehicle 105 will not operate within the first area 200. In the case that the projected path of the vehicle 105 intersects the boundary of the first area 200, the server 160 can predict the vehicle 105 will operate within the first area 200. In this case, the server 160 can transmit the first area 200 operating parameters to the vehicle computer 110. The vehicle computer 110 can then actuate one or more vehicle components 125 to control the vehicle 105 according to the first area 200 operating parameters upon entering the first area 200, i.e., crossing the boundary of the first area 200. As another example, the vehicle computer 110 may provide a planned path to the server 160, e.g., via the network 135. As used herein, a “planned path” is a set of points, e.g., that can be specified as coordinates with respect to a vehicle coordinate system, an infrastructure coordinate system, and/or geo-coordinates, that the vehicle computer 110 is programmed to determine with a conventional navigation and/or path-planning algorithm. The server 160 can then predict whether the vehicle 105 will operate within the first area 200 based on the planned path.

The server 160 is programmed to provide the second area 300 operating parameters for a second area 300 to the vehicle computer 110 based on the vehicle 105 operating within the second area 300. For example, the server 160 can determine the vehicle 105 is operating within the second area 300 based on receiving location data from the vehicle computer 110. As another example, the server 160 may determine the vehicle 105 is operating within the second area 300 based on receiving infrastructure sensor 145 data detecting the vehicle 105 from an infrastructure computer 155 within the second area 300. The vehicle computer 110 can then operate the vehicle 105 within the second area 300 based on the second area 300 operating parameters. That is, the vehicle computer 110 can actuate one or more vehicle components 125 to operate the vehicle 105 at the distance from a second vehicle 106 and the speed specified by the second area 300 operating parameters for the second area 300.

Additionally, or alternatively, the server 160 can predict whether a vehicle 105 will operate within a second area 300 based on determining the projected path of the vehicle 105 and determining whether the vehicle 105 is within a boundary of the second area 300. The boundary of the second area 300 is defined by a field of view of the infrastructure sensor 145 within the second area 300. For example, the server 160 can determine the projected path of the vehicle 105 based on the heading received from the vehicle computer 110, e.g., via the network 135, and the GPS coordinate system. Additionally, the server 160 can determine whether the vehicle 105 is within the second area 300 based on receiving location data from the vehicle computer 110 or the infrastructure computer 155 within the second area 300.

The server 160 can then compare the projected path of the vehicle 105 to the second area 300. In the case that the projected path of the vehicle 105 does not intersect the boundary of the second area 300 and the vehicle 105 is outside the second area 300, the server 160 predicts the vehicle 105 will not operate within the second area 300. In the case that the projected path of the vehicle 105 intersects the boundary of the second area 300 and the vehicle 105 is outside the second area 300, the server 160 can predict the vehicle 105 will operate within the second area 300. In these circumstances, the server 160 can transmit the second area 300 operating parameters for the second area 300 to the vehicle computer 110. The vehicle computer 110 can then actuate one or more vehicle components 125 to control the vehicle 105 according to the second area 300 operating parameters for the second area 300 upon entering the second area 300, i.e., crossing the boundary of the second area 300. As another example, the vehicle computer 110 may provide a planned path to the server 160, e.g., via the network 135. The server 160 can then predict whether the vehicle 105 will operate within the second area 300 based on the planned path.

In the case that the vehicle 105 is within the second area 300 and the projected path of the vehicle 105 is towards the infrastructure sensor 145 (e.g., such that the infrastructure sensor 145 may detect a front of the vehicle 105) within the second area 300, the server 160 predicts the vehicle 105 will not depart within the second area 300. In the case that the vehicle 105 is within the second area 300 and the projected path of the vehicle 105 is away from the infrastructure sensor 145 (e.g., such that the infrastructure sensor 145 may detect a rear of the vehicle 105) within the second area 300, the server 160 can predict the vehicle 105 will depart the second area 300. In these circumstances, the server 160 can transmit the first area 200 operating parameters to the vehicle computer 110. The vehicle computer 110 can then actuate one or more vehicle components 125 to control the vehicle 105 according to the first area 200 operating parameters upon departing the second area 300, i.e., crossing the boundary of the second area 300. As another example, the vehicle computer 110 may provide a planned path to the server 160, e.g., via the network 135. The server 160 can then predict whether the vehicle 105 will depart the second area 300 based on the planned path.

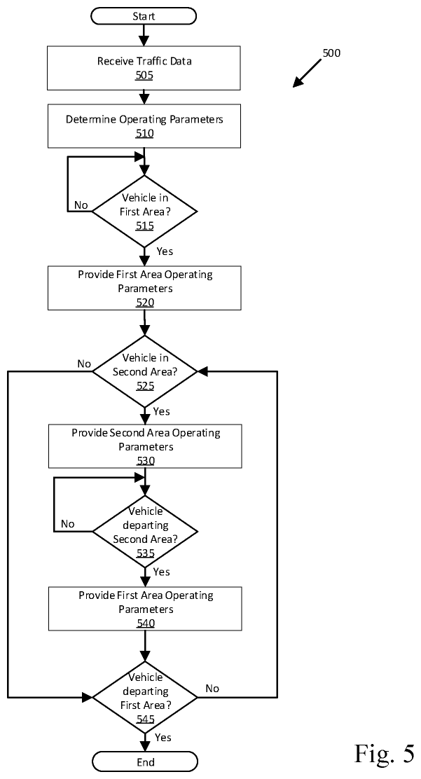

FIG. 5 is a diagram of an example process 500 for controlling vehicle 105 operating parameters. The process 500 begins in a block 505.

In the block 505, the server 160 receives traffic data, e.g., specifying at least one of a vehicle reaction time, a pedestrian count, a traffic count, a traffic flow, and traffic violations, from the infrastructure computers 155 within a respective first area 200, e.g., via the network 135. For example, each infrastructure sensor 145 can capture data, e.g., image and/or video data, of respective second areas 300 within a first area 200 and transmit the data to a respective infrastructure computer 155. Each infrastructure computer 155 can then analyze the respective infrastructure sensor 145 data, as discussed above, to determine the traffic data of the respective second area 300 and transmit the traffic data of the respective second area 300 to the server 160. The process 500 continues in a block 510.

In the block 510, the server 160 determines first area 200 operating parameters for respective first areas 200 and second area 300 operating parameters for respective second areas 300 within each first area 200. The server 160 determines first area 200 operating parameters of the vehicle 105 based on the traffic data received from the infrastructure computers 155 within the respective first area 200. For example, the server 160 can include a neural network, such as discussed above, that can be trained to accept traffic data, e.g., data indicating at least one of a vehicle reaction time, a pedestrian count, a traffic count, a traffic flow, and traffic violations, from each infrastructure computer 155 within the respective first area 200 as input and generate an output of the first area 200 operating parameters for the respective first area 200, as discussed above.

Additionally, the server 160 determines second area 300 operating parameters of the vehicle 105 based on the traffic data received from the infrastructure computer 155 in the respective second area 300 and/or sensor 115 data from the vehicle 105 operating within the respective second area 300. For example, the server 160 can include a neural network, such as discussed above, that can be trained to accept traffic data, e.g., data indicating at least one of a vehicle reaction time, a pedestrian count, a traffic count, a traffic flow, and traffic violations, from the infrastructure computer 155 within a second area 300 and/or sensor 115 data from the vehicle 105 as input and generate an output of the second area 300 operating parameters for the respective second area 300, as discussed above. The server 160 can then store the first area 200 operating parameters for respective first areas 200 and the second area 300 operating parameters for respective second areas 300, e.g., in a memory. The process 500 continues in a block 515.

In the block 515, the server 160 determines whether the vehicle 105 is within a first area 200. For example, the server 160 can receive location data from the vehicle computer 110, e.g., via the network 135, indicating the vehicle 105 is within the first area 200. As another example, the server 160 can receive image data from an infrastructure computer 155 within the first area 200, e.g., via the network 135, indicating the vehicle 105 is within the first area 200. Alternatively, the server 160 can predict the vehicle 105 will enter the first area 200 based on a heading and/or a planned path received from the vehicle computer 110, as discussed above. In the case that the server 160 determines the vehicle 105 is within the first area 200, the process 500 continues in a block 520. Otherwise, the process 500 remains in the block 515.

In the block 520, the server 160 provides the first area 200 operating parameters for the respective first area 200 to the vehicle computer 110. For example, the server 160 can transmit the first area 200 operating parameters to the vehicle computer 110, e.g., via the network 135. The vehicle computer 110 can then operate the vehicle 105 in the first area 200 based on the first area 200 operating parameters, e.g., at the distance from a second vehicle 106 and the speed specified by the first area 200 operating parameters, as discussed above. The process 500 continues in a block 525.

In the block 525, the server 160 determines whether the vehicle 105 is within a second area 300. For example, the server 160 can receive location data from the vehicle computer 110, e.g., via the network 135, indicating the vehicle 105 is within the second area 300. As another example, the server 160 can receive image data from an infrastructure computer 155 within the second area 300, e.g., via the network 135, indicating the vehicle 105 is within the second area 300. Alternatively, the server 160 can predict the vehicle 105 will enter the second area 300 based on a heading and/or a planned path received from the vehicle computer 110, as discussed above. In the case that the server 160 determines the vehicle 105 is within the second area 300, the process 500 continues in a block 530. Otherwise, the process 500 continues in a block 545.

In the block 530, the server 160 provides the second area 300 operating parameters for the respective second area 300 to the vehicle computer 110. For example, the server 160 can transmit the second area 300 operating parameters to the vehicle computer 110, e.g., via the network 135. The vehicle computer 110 can then operate the vehicle 105 in the second area 300 based on the second area 300 operating parameters, e.g., at the distance from a second vehicle 106 and the speed specified by the second area 300 operating parameters, as discussed above. The process 500 continues in a block 535.

In the block 535, the server 160 determines whether the vehicle 105 departed the second area 300. For example, the server 160 can receive location data from the vehicle computer 110 indicating the vehicle 105 is outside the second area 300. As another example, the server 160 can receive image data from an infrastructure computer 155 within the second area 300, e.g., via the network 135, indicating the vehicle 105 is outside the second area 300. Alternatively, the server 160 can predict the vehicle 105 will depart the second area 300 based on a heading and/or a planned path received from the vehicle computer 110, as discussed above. In the case that the server 160 determines the vehicle 105 departed the second area 300, the process 500 continues in a block 540. Otherwise, the process 500 remains in the block 535.

In the block 540, the server 160 provides the first area 200 operating parameters for the first area 200 to the vehicle computer 110. That is, the server 160 determines the vehicle 105 is within the first area 200 upon departing the second area 300. For example, the server 160 can transmit the first area 200 operating parameters to the vehicle computer 110, e.g., via the network 135. The vehicle computer 110 can then operate the vehicle 105 in the first area 200 based on the first area 200 operating parameters, e.g., at the distance from a second vehicle 106 and the speed specified by the first area 200 operating parameters, as discussed above. The process 500 continues in a block 545.

In the block 545, the server 160 determines whether the vehicle 105 departed the first area 200. For example, the server 160 can receive location data from the vehicle computer 110 indicating the vehicle 105 is outside the first area 200. As another example, the server 160 can receive image data from an infrastructure computer 155 within the second area 300, e.g., via the network 135, indicating the vehicle 105 is outside the first area 200. Alternatively, the server 160 can predict the vehicle 105 will depart the first area 200 based on a heading and/or a planned path received from the vehicle computer 110, as discussed above. In the case that the server 160 determines the vehicle 105 departed the first area 200, the process 500 ends. Otherwise, the process 500 returns to in the block 525.

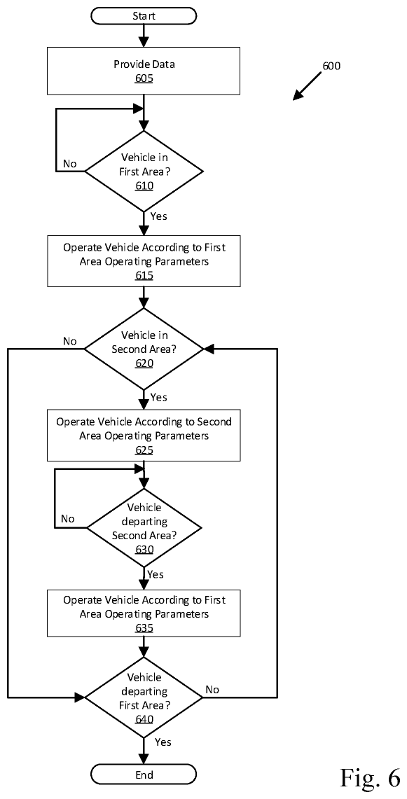

FIG. 6 is a diagram of an example process 600 for operating a vehicle 105 according to received operating parameters. The process 600 begins in a block 605.

In the block 605, the vehicle computer 110 provides data to the server 160, e.g., via the network 135. The data may specify a location, e.g., GPS coordinates, of the vehicle 105. Additionally, or alternatively, the data may specify a planned path and/or a heading of the vehicle 105. The server 160 may be programmed to provide one of the first area 200 operating parameters or the second area 300 operating parameters to the vehicle computer 110 based on the data, as discussed above. The process 600 continues in a block 610.

In the block 610, the vehicle computer 110 determines whether the vehicle 105 is within a first area 200. For example, the vehicle computer 110 can receive data from the server 160, e.g., via the network 135, specifying a boundary of the first area 200, e.g., defined by GPS coordinates. The vehicle computer 110 can then compare the location of the vehicle 105 to the GPS coordinates of the first area 200. The vehicle computer 110 can determine the vehicle 105 is within the first area 200 in the case that the location of the vehicle 105 is within the boundary of the first area 200. As another example, the vehicle computer 110 can receive a message from the server 160 specifying the vehicle 105 is within the first area 200, e.g., based on image data from an infrastructure computer 155. In the case that the vehicle 105 is within the first area 200, the process 600 continues in a block 615. Otherwise, the process 600 remains in the block 610.

In the block 615, the vehicle computer 110 operates the vehicle 105 according to the first area 200 operating parameters. For example, the vehicle computer 110 receives the first area 200 operating parameters from the server 160, e.g., via the network 135, as discussed above. The vehicle computer 110 can then actuate one or more vehicle components 125 to operate the vehicle 105 according to the first area 200 operating parameters. For example, the vehicle computer 110 can actuate a propulsion component 125 and/or braking component 125 to operate the vehicle 105 at the distance from a second vehicle 106 and the speed specified by the first area 200 operating parameters. The process 600 continues in a block 620.

In the block 620, the vehicle computer 110 determines whether the vehicle 105 is within a second area 300. For example, the vehicle computer 110 can receive data from the server 160, e.g., via the network 135, specifying a boundary of the second area 300, e.g., defined by GPS coordinates. The vehicle computer 110 can then compare the location of the vehicle 105 to the GPS coordinates of the second area 300. The vehicle computer 110 can determine the vehicle 105 is within the second area 300 in the case that the location of the vehicle 105 is within the boundary of the second area 300. As another example, the vehicle computer 110 can receive a message from the server 160 specifying the vehicle 105 is within the second area 300, e.g., based on image data from an infrastructure computer 155 within the second area 300. In the case that the vehicle 105 is within the second area 300, the process 600 continues in a block 625. Otherwise, the process 600 continues in a block 640.

In the block 625, the vehicle computer 110 operates the vehicle 105 according to the second area 300 operating parameters. For example, the vehicle computer 110 receives the second area 300 operating parameters from the server 160, e.g., via the network 135, as discussed above. The vehicle computer 110 can then actuate one or more vehicle components 125 to operate the vehicle 105 according to the second area 300 operating parameters. For example, the vehicle computer 110 can actuate a propulsion component 125 and/or braking component 125 to operate the vehicle 105 at the distance from a second vehicle 106 and the speed specified by the second area 300 operating parameters. The process 600 continues in a block 630.

In the block 630, the vehicle computer 110 determines whether the vehicle 105 departed the second area 300. For example, the vehicle computer 110 can receive data from the server 160, e.g., via the network 135, specifying a boundary of the second area 300, e.g., defined by GPS coordinates. The vehicle computer 110 can then compare the location of the vehicle 105 to the GPS coordinates of the second area 300. The vehicle computer 110 can determine the vehicle 105 is outside the second area 300 in the case that the location of the vehicle 105 is outside the boundary of the second area 300. As another example, the vehicle computer 110 can receive a message from the server 160 specifying the vehicle 105 is outside the second area 300, e.g., based on image data from an infrastructure computer 155 within the second area 300. In the case that the vehicle 105 is outside the second area 300, the process 600 continues in a block 635. Otherwise, the process 600 remains in the block 630.

In the block 635, the vehicle computer 110 operates the vehicle 105 according to the first area 200 operating parameters. For example, the vehicle computer 110 receives the first area 200 operating parameters from the server 160, e.g., via the network 135, as discussed above. The vehicle computer 110 can then actuate one or more vehicle components 125 to operate the vehicle 105 according to the first area 200 operating parameters. For example, the vehicle computer 110 can actuate a propulsion component 125 and/or braking component 125 to operate the vehicle 105 at the distance from a second vehicle 106 and the speed specified by the first area 200 operating parameters. The process 600 continues in the block 640.

In the block 640, the vehicle computer 110 determines whether the vehicle 105 departed the first area 200. For example, the vehicle computer 110 can receive data from the server 160, e.g., via the network 135, specifying a boundary of the first area 200, e.g., defined by GPS coordinates. The vehicle computer 110 can then compare the location of the vehicle 105 to the GPS coordinates of the first area 200. The vehicle computer 110 can determine the vehicle 105 is outside the first area 200 in the case that the location of the vehicle 105 is outside the boundary of the first area 200. As another example, the vehicle computer 110 can receive a message from the server 160 specifying the vehicle 105 is outside the first area 200, e.g., based on image data from an infrastructure computer 155. In the case that the vehicle 105 is outside the first area 200, the process 600 ends. Otherwise, the process 600 returns to the block 620.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to:
determine first area operating parameters specifying operation of a vehicle within a first area based on traffic data received from a plurality of infrastructure sensors within the first area;
determine second area operating parameters specifying operation of the vehicle within a second area based on traffic data received from the infrastructure sensor within the second area, wherein the second area is a subset that is less than all of the first area;
upon the vehicle operating within the first area, provide the first area operating parameters to the vehicle; and
upon the vehicle operating within the second area, provide the second area operating parameters to the vehicle.

2. The system of claim 1, wherein the first area operating parameters and the second area operating parameters each specify at least a distance of the vehicle from a second vehicle and a speed of the vehicle.

3. The system of claim 1, wherein determining the second area operating parameters includes obtaining the second area operating parameters as output from a deep neural network.

4. The system of claim 3, wherein the instructions further include instructions to input the traffic data received from the infrastructure sensor within the second area into the deep neural network, wherein traffic data includes data indicating at least one of vehicle reaction time, pedestrian count, vehicle count, traffic flow, and traffic violations.

5. The system of claim 4, wherein the instructions further include instructions to input sensor data received from the vehicle into the deep neural network, wherein the sensor data includes image data and location data.

6. The system of claim 3, wherein the instructions further include instructions to train the deep neural network with simulated data generated from image data received from infrastructure sensor.

7. The system of claim 3, wherein determining the first area operating parameters includes obtaining the first area operating parameters as output from the deep neural network.

8. The system of claim 7, wherein the instructions further include instructions to input the traffic data received from the plurality of infrastructure sensors within the first area into the deep neural network, wherein traffic data includes data indicating at least one of vehicle reaction time, pedestrian count, vehicle count, traffic flow, and traffic violations.

9. The system of claim 7, wherein the instructions further include instructions to train the deep neural network with simulated data generated from image data received from the plurality of infrastructure sensors.

10. The system of claim 1, wherein traffic data includes data indicating at least one of vehicle reaction time, pedestrian count, vehicle count, traffic flow, and traffic violations.

11. The system of claim 1, wherein the instructions further include instructions to, upon the vehicle departing the second area, provide the first area operating parameters to the vehicle.

12. The system of claim 11, wherein the instructions further include instructions to predict the vehicle will depart the second area based on a location and a heading of the vehicle.

13. The system of claim 1, wherein the instructions further include instructions to predict the vehicle will enter the second area based on a location and a heading of the vehicle.

14. The system of claim 1, wherein the second area is an intersection.

15. The system of claim 1, further comprising a vehicle computer in communication with the computer via a network, the vehicle computer including a processor and a memory storing instructions executable by the processor to:
receive the first area operating parameters or the second area operating parameters from the computer; and
actuate one or more vehicle components to operate the vehicle according to the received operating parameters.

16. A method comprising:
determining first area operating parameters specifying operation of a vehicle within a first area based on traffic data received from a plurality of infrastructure sensors within the first area;
determining second area operating parameters specifying operation of the vehicle within a second area based on traffic data received from the infrastructure sensor within the second area, wherein the second area is a subset that is less than all of the first area;
upon the vehicle operating within the first area, providing the first area operating parameters to the vehicle; and
upon the vehicle operating within the second area, providing the second area operating parameters to the vehicle.

17. The method of claim 16, wherein the first area operating parameters and the second area operating parameters each specify at least a distance of the vehicle from a second vehicle and a speed of the vehicle.

18. The method of claim 16, wherein traffic data includes data indicating at least one of vehicle reaction time, pedestrian count, vehicle count, traffic flow, and traffic violations.

19. The method of claim 16, further comprising, upon the vehicle departing the second area, providing the first area operating parameters to the vehicle.

20. The method of claim 16, further comprising predicting the vehicle will enter the second area based on a location and a heading of the vehicle.
